(19) United States
(12) Patent Application Publication
(10) Pub. No.: US 2015/0090728 A1
(43) Pub. Date: Apr. 2, 2015

(54) CONTAINERS INCLUDING INSULATING MATERIALS

(71) Applicant: Caralon Global Limited, Milton Keynes (GB)

(72) Inventors: Neil D. LUBART, Austin, TX (US); Timothy J. WOJCIECHOWSKI, Westlake, OH (US); Charles HEWITT, London (GB); Timothy BARKER, Woking (GB)

(21) Appl. No.: 14/566,891

(22) Filed: Dec. 11, 2014

Related U.S. Application Data
(63) Continuation of application No. 13/937,159, filed on Jul. 8, 2013, now abandoned.
(60) Provisional application No. 61/668,798, filed on Jul. 6, 2012.
(60) Provisional application No. 61/806,552, filed on Mar. 29, 2013.

(51) Int. Cl. B65D 81/38; B31B 7/00

(52) U.S. Cl. CPC B65D 81/3818; B65D 81/3823; B31B 7/00
USPC 220/592.21; 220/592.27; 493/96

(57) ABSTRACT

Insulated containers including at least one insulating material are described herein. The containers may include structures that maximize vacuum area relative to material volume. Certain containers may be configured to minimize the area of contact between material layers within a region to be insulated in order to provide maximum thermal resistance between the contacted area and the external environment. The insulated containers may be formed from a container opening enclosed within a container cover. A cavity may be formed within the space between the container opening and the container cover. The cavity may be vacuum sealed to prevent or reduce thermal leaks from the insulated container. The insulating material may include multiple material layer separated by layer cavities. The material layers may include projections arising from a base surface thereof for preventing the material layers from contacting each other, for instance, and causing a thermal short.

### CROSS-REFERENCE TO RELATED APPLICATIONS

This application is a continuation of U.S. patent application Ser. No. 13/937,159 filed on Jul. 8, 2013, which claims the benefit of U.S. Provisional Application Nos. 61/668,798, filed on Jul. 6, 2012, and 61/806,552, filed on Mar. 29, 2013, the contents of which are incorporated by reference in their entirety as if fully set forth herein.

### BACKGROUND

Thermal devices, such as vacuum insulation panels (VIPs) and other thermal insulation devices, are used in many industries to control the temperature of an object or structure. For instance, thermal panels may be used in construction materials, such as wall and floor insulation materials, for buildings in an effort to regulate temperature. In another instance, refrigeration equipment may include materials that limit the effects of the outside environment on the low temperature interior of the refrigeration equipment, such as a commercial freezer. However, the effectiveness of such materials constructed according to conventional technology is often susceptible to thermal leakage, particularly at the edges and joints where various layers of material come together. Accordingly, it would be beneficial to provide a thermal insulation device formed from multiple layers of materials that is capable of being used in a wide range of products in which thermal leakage is reduced or even eliminated.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, an insulated container may comprise a container body comprising an opening providing access to a cavity disposed therein, the container body comprising at least one insulating material, and a container cover configured to surround at least a portion of the container body around the opening in contact with at least a portion of an outer surface of the container body, thereby forming a vacuum seal between the container cover and the at least a portion of the outer surface of the container body, the vacuum seal operating to prevent thermal leaks from the insulated container, wherein the insulated container is configured to provide insulation for at least one object.

In an embodiment, an insulated case assembly may comprise a case body comprising at least one insulating material, the case body having at least one opening providing access to a cavity disposed therein, the case body being configured to receive at least one object through the opening; and a case cover configured to move between a closed position in which the case cover covers the at least one opening and seals the cavity and an open position in which the at least one opening is exposed, wherein the insulated case assembly is configured to provide insulation for at least one object.

### BRIEF DESCRIPTION OF THE DRAWINGS

FIG. 1 depicts an illustrative insulating material according to an embodiment.

FIG. 2 depicts an illustrative container including an insulating material according to an embodiment.

FIG. 3 depicts an illustrative container having multiple insulating material layers according to an embodiment.

FIG. 4 depicts an illustrative container including fold-over edges according to an embodiment.

FIGS. 5A and 5B depict an illustrative multi-layer container having an abutment according to an embodiment.

FIG. 6 depicts an illustrative insulated case assembly comprising a hinged cover according to some embodiments.

FIG. 7 depicts an illustrative insulated case assembly comprising a hinged cover in a closed position according to some embodiments.

FIG. 8 depicts an illustrative insulated case assembly comprising a hinged cover in an open position according to some embodiments.

FIG. 9 depicts an illustrative insulated case assembly comprising a removable cover according to some embodiments.

FIGS. 10A-10H depict illustrative insulated case assemblies according to some embodiments.

### DETAILED DESCRIPTION

The terminology used herein is for the purpose of describing particular versions or embodiments only and is not intended to limit the scope of the described technology. Unless defined otherwise, all terms of art, notations, and other scientific terms or terminology used herein have the same meaning as is commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

In this disclosure, the following meanings are attributed to the terms employed.

As used herein, the singular forms “a”, “an”, and “the” means at least one, but may also include plural reference unless the context clearly dictates otherwise.

As used herein, the term “about” means plus or minus 10% of the numerical value of the number with which it is being used. Therefore, about 50% means in the range of 40%-60%.

As used herein, the terms “device” and “insulating material device” refer to the insulating material in its end use application.

The terms “insulating material”, “insulating film”, and “thermal resistant layer” are used interchangeably herein.

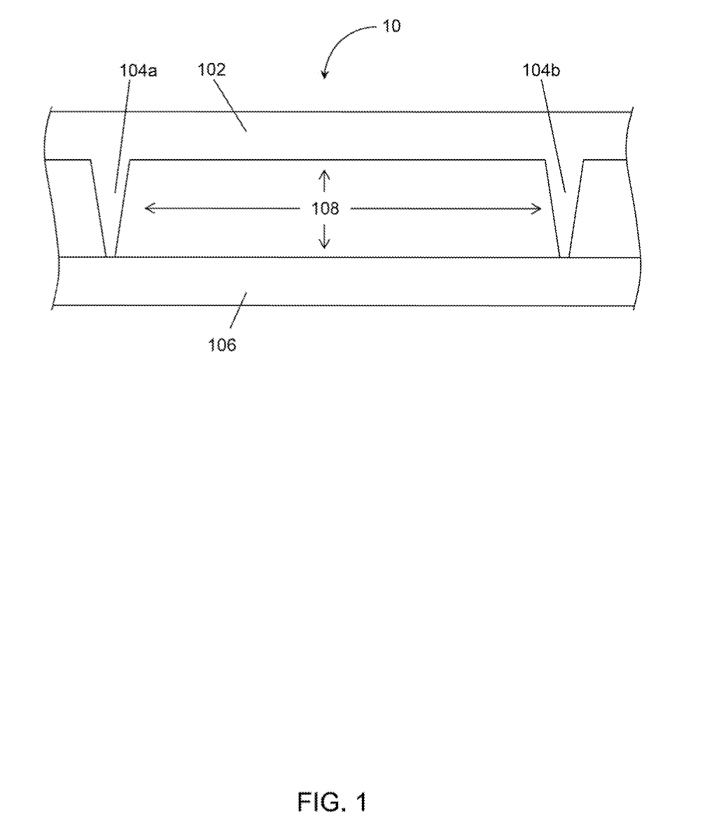

The described technology is directed to containers composed of an insulating material including at least cavity between parallel layers of a structural material. The cavity, which may be a vacuum cavity, may extend throughout the insulating material, and one or both of the parallel layers of structural material may include projections positioned to maintain the volume of the cavity while under vacuum. The projections may extend from either or both of the two boundary walls. FIG. 1 depicts an illustrative insulating material, 10, showing a first material layer, 102, having projections, 104a, 104b, that contact a second material layer, 106. A cavity, 108, may be formed between the first material layer, 102, and the second material layer, 106. The projections, 104a, 104b, may be configured to separate the first material layer, 102, and the second material layer, 106, and maintain the size and shape of the cavity, 108. For example, the projections, 104a, 104b, may be configured to ensure that the first material layer, 102, and the second material layer, 106, do no touch and/or cause a thermal short between the first and second material layers, 102, 106, causing a reduction in the insulating properties of the article. In this manner, the projections, 104a, 104b, may provide support to insulating material, 10, while reducing contact between the first and second material layers, 103, 106. For example, in particular embodiments, about 1% or less of the total surface area of a projection 104a, 104b extending from the first material layer 102 may contact a surface of a second material layer 106. In an embodiment, the projections, 104a, 104b, may be formed from the same piece of material as the layer (for example, first and/or second material layers, 103, 106) from which they project, for instance, through an injection molding and/or three-dimensional printing process. As such, the projections and the layer (for example, first and/or second material layers, 103, 106) from which they project may be configured as one solid piece or layer.

The arrangement of the first material layer, 102, and the second material layer, 106, may be a double-wall configuration including a first wall (for example, the first material layer) and a second wall (for example, the second material layer) separated by a cavity, 108. In some embodiments, a vacuum may be created within the cavity, 108, and in other embodiments, the cavity, 108, may be filled with, for example, air, an inert gas, or another insulating material such as an insulating foam, aerogel, glass fibers, and/or a fluid. In embodiments in which a vacuum is applied within the cavity, the level of vacuum may vary and may depend on the use of the container. In some embodiments, the vacuum may be near vacuum pressure at less than 10⁻² bar to as low as 10⁻⁸ bar. For example, the vacuum pressure may be from about 10⁻² bar to about 10⁻⁹ bar, about 10⁻³ bar to about 10⁻⁸ bar, about 10⁻⁴ bar to about 10⁻⁸ bar, or about 10⁻⁵ bar to about 10⁻⁸ bar, or any pressure between these illustrative ranges (including endpoints). In still further embodiments, the cavity may include desiccants or other materials useful for reducing or eliminating gases and moisture that may enter the cavity. Such desiccants are not limited to any particular kind or type of desiccant and may include, but are not limited to, aluminum, silver, indium, nickel, gold, aluminum oxide, aluminum nitride, aluminum oxynitride, silicon oxides, silicon carbide, silicon nitride, silicon oxynitride, indium tin oxide, or the like, and combinations thereof. In other embodiments, the cavity, 108, may include nanoparticles (or nano-desiccants) capable of absorbing gases and moisture that may enter the cavity. Such nanoparticles may include, but are not limited to, alumina, silica, mica, silver, indium, nickel, gold, aluminum suboxide, aluminum oxynitride, silicon suboxide, silicon carbide, silicon oxynitride, indium zinc oxide, indium tin oxide nanoparticles, and the like and combinations thereof. In still further embodiments, the nanoparticles may be desiccant nanoparticles prepared from material including, but not limited to, calcium chloride, calcium sulfate, phosphorus pentoxide, other water-retaining polymers, or the like, and combinations thereof.

The containers of various embodiments may be of any size or shape. For example, the containers may be a cross-sectional shape that is circular, square, rectangular, triangular, elliptical, oval, lobe-shaped, pentagonal, hexagonal, heptagonal, octagonal, or the like, or similar configurations. In some embodiments, the containers may be open on both ends, and in other embodiments, one or both ends of the containers may be enclosed by the insulating material or by another material that may or may not include a vacuum cavity.

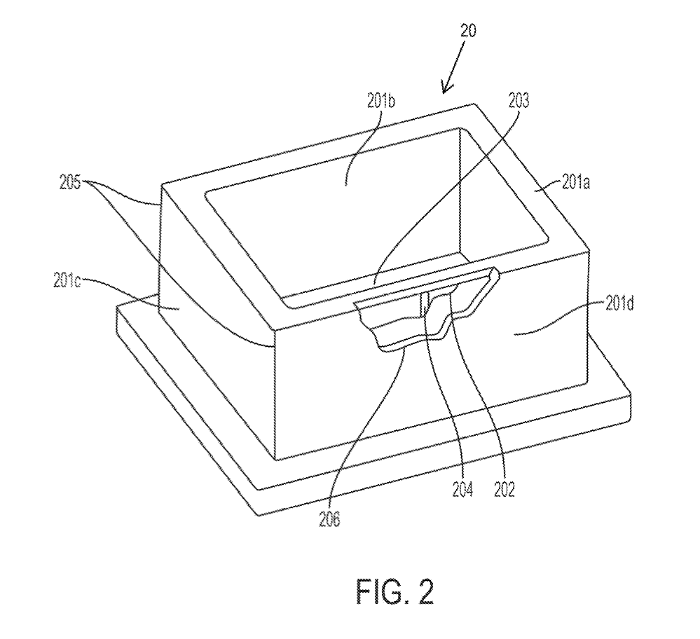

In certain embodiments, the containers may have a box shape. An illustrative embodiment of such a box shaped article is provided in FIG. 2, the container (or container body), 20, may include at least 5 sides, 4 sides, 201a, 201b, 201c, 201d, joined on opposing sides to create a rectangle and a base, 203, enclosing one end of the article. In some embodiments, each of the 4 sides 201a, 201b, 201c, 201d, may be composed of an insulating material, such as one of the illustrative insulating materials described with respect to FIG. 1. The components of the insulating material illustrated in FIG. 2 may include a first material layer 202 and a second material layer, 206, arranged in a double-wall configuration and one or more projections, 204. In other embodiments, each of the four sides 201a, 201b, 201c, 201d, and the base, 203, may be composed of such an insulating material, and still in other embodiments, the base, 203, may be composed of an insulating material and each of the four sides 201a, 201b, 201c, 201d, may be composed of a non-insulating material.

According to some embodiments, any surface (for example, the sides 201a, 201b, 201c, 201, the base 203, the one or more projections, 204, (and/or the projections, 104a, 104b) of an insulated container configured according to some embodiments described herein may be at least partially coated with a desiccant, such as a nano-desiccant. In an embodiment, the desiccant may be activated after a vacuum has been applied to at least a portion of the insulated container.

In some embodiments, two or more of the four sides and the base may be constructed from a single sheet of the insulating material, formed to create the rectangular structure. In such embodiments, the cavity of the insulating material (not shown) may be substantially maintained in each of the four sides, and each of corners 205 joining each of the four sides may be formed to preserve the cavity. As such, the corners 205 may consist of two or more angled joints arranged in close proximity to one another that in their aggregate create an about 90° angle. For example, each corner, 205, may be created from two 45° angled joints, three 30° angled joints, four 22.5° angled joints, or the like, and combinations of these. In certain embodiments, each corner 205 may be rounded or curved to create a corner that allows for maintenance of the cavity at the corners.

Some embodiments further include boxes having sides 201a, 201b, 201c, 201d, and/or a base, 203, having two or more layers of insulating material. For example, in some embodiments, each side, 201a, 201b, 201c, 201d, and/or the base, 203, may be constructed from an insulating material similar to the exemplary insulating material described in reference to FIG. 1 having two or more cavities created between parallel layers of structural material. In other embodiments, insulating materials, such as those described in reference to FIG. 1 may be combined with, for example, foam or other known insulating materials to form multi-layer insulating devices. In particular embodiments, boxes having two or more layers of insulating material may be may be prepared by providing a box within a box configuration.

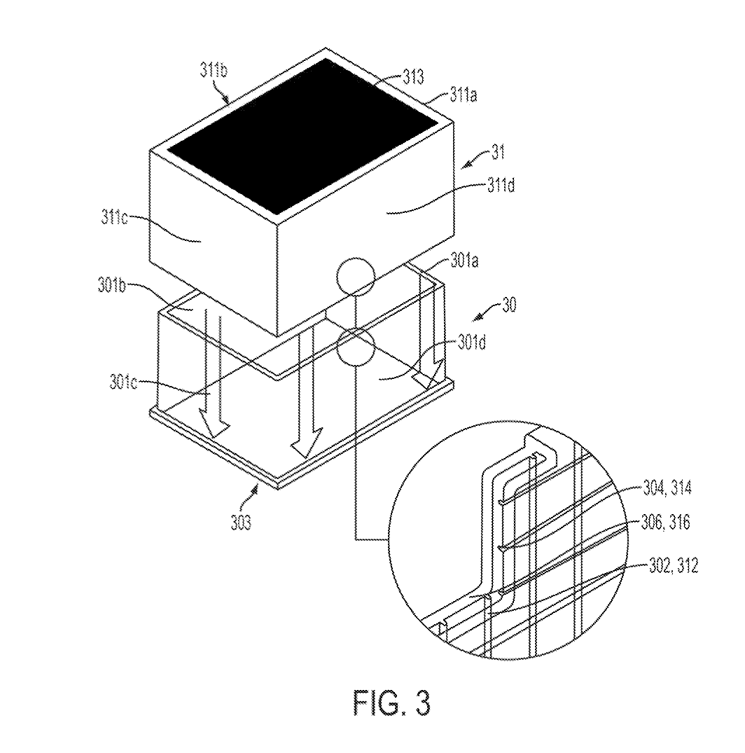

As illustrated in FIG. 3, in some embodiments, a first box (or container body), 30, including one or more sides (or side walls), 301a, 301b, 301c, 301d, and base (or base wall), 303, and a second box (or container cover), 31, including one or more sides, 311a, 311b, 311c, 311d, and base, 313, each having at least one side or base composed of an insulating material such as one of the illustrative insulating materials described in FIG. 1, can be sized such that the first box, 30, fits within the second box, 31. As shown in FIG. 3, the one or more sides, 301a, 301b, 301c, 301d, and base, 303 of the first box, 30, one or more sides, 311a, 311b, 311c, 311d, and base, 313, of the second box, 31 may be configured as double-wall structures, as depicted in the inset of FIG. 3. In an embodiment, the cavity located between the double-wall structures may be under vacuum such that an insulated container formed from combining the first box, 30, and the second box, 31, may be formed from two boxes each including double-wall structures with a vacuum cavity arranged therebetween.

The first box, 30, may be inserted into the second box, 31, to provide the multi-layer box such that the exterior, first material layer, 302, of the first box, 30, and the interior, second material layer, 316, of the second box, 31, may be contiguous with one another along each side and their bases, 303, 313. As above, one or more sides, 301a, 301b, 301c, 301d, and base, 303 of the first box, 30, and one or more sides, 311a, 311b, 311c, 311d, and base, 313, of the second box, 31, may be prepared from the insulating materials described above (see inset). These sides and bases may include first structural material, 302, 312, second structural material, 306, 316, and one or more projections 304, 314. Contact between the first box, 30, and the second box, 31, may be maintained by friction or an adhesive layer, and may be disposed between the interior, second material layer, 306, of the first box, 30, and the exterior, first material layer, 312, of the second box, 31. Contact between the first box, 30, and the second box, 31, may be maintained by friction or an adhesive layer disposed between the first box, 30, and the second box, 31.

In some embodiments, the contact between the first box, 30, and the second box, 31, may be thermally minimized by providing projections extending from one or more surfaces of either box or both boxes. In still other embodiments, the first and second boxes, 30, 31, may be separated by air. For example, an air gap may be formed between the sides of the boxes 30, 31. In an embodiment, the one or more projections, 304, of the first box, 30, may run orthogonal to the one or more projections, 314, of the second box, 31. In an embodiment, one or more additional material layers (not shown) may be arranged between the first and second boxes, 30, 31 that include, without limitation, desiccants, projections, and/or reflective materials (including reflective materials with low emissivity).

When the first box, 30, and the second box, 31, are brought together, the radius around the first box, 30, (for example, the space between the one or more sides, 301a, 301b, 301c, 301d, of the first box and the one or more sides, 311a, 311b, 311c, 311d, of the second box) may form a cavity that may be vacuum sealed. This cavity may be configured to prevent or reduce edge leaks of the insulated container formed by the combination of the first box, 30, and the second box, 31. According to some embodiments, any cavity formed between the one or more sides, 301a, 301b, 301c, 301d, of the first box, 30, and the one or more sides, 311a, 311b, 311c, 311d, of the second box, 31, may be vacuum sealed. According to some embodiments, the area of vacuum within the radius may be arranged within the area defined by the outer edge of the base, 303, that contacts the lower portion of the one or more sides, 301a, 301b, 301c, 301d, of the first box, 30, and the space between the one or more sides of the first box and the one or more sides, 311a, 311b, 311c, 311d, of the second box, 31, and the inner surface of the base, 313, of the second box.

According to some embodiments, the cavity formed between the first box, 30, and the second box, 31, (for example, the cavity formed by the inner surface of one or more sides, 301a, 301b, 301c, 301d, and the inner surface of base, 313) may be vacuum sealed or may not be vacuum sealed, depending on requirements. In an embodiment, the one or more sides, 301a, 301b, 301c, 301d, the one or more sides 311a, 311b, 311c, 311d, and/or other components of the insulated container may include openings, such as small holes, to allow for the generation of vacuum therein. The openings may be sealed after the vacuum pressure has been achieved.

Open air thermal conducting paths between the open end of one box and the closed end of a second box may be minimized in some embodiments. As such, in some embodiments, a capping or sealing material (not shown) may be disposed over the joint between the first box, 30, and the second box, 31, at an open end of the multilayer box. The capping material may be provided to maintain the connection between the first box, 30, and the second box, 31, to improve aesthetics of multi-layer box, or to provide an additional layer of structural material on this surface to improve resilience of this surface of the multilayer box. Various components of an insulated container configured according to some embodiments, such as the first box, 30, and/or the second box, 31, may be assembled under vacuum.

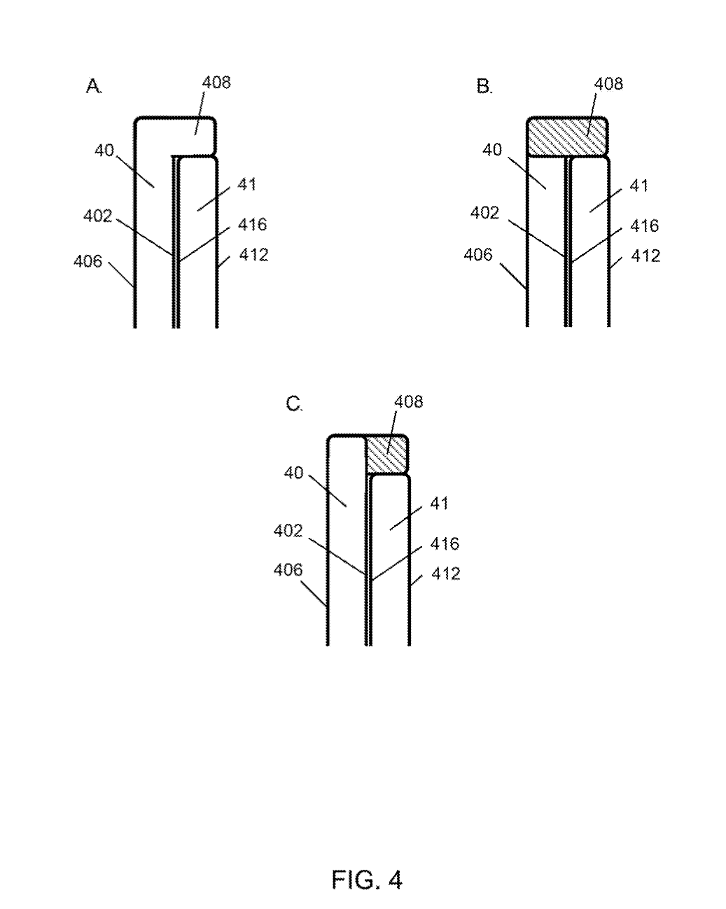

FIG. 4 depicts an illustrative container including fold-over edges according to an embodiment. According to some embodiments, the first box, 30, may be designed to include a fold-over outer edge, 408, opposite the base of the multilayer box. FIG. 4 shows a side of the multilayer box in cross-section including the exterior, first material layer, 402, of the first box, 40, and the interior, second material layer, 416, of the second box, 41, and the interior, second material layer, 406, of the first box, 40, and the exterior, first material layer, 412, of the second box, 41. The outer edge, 408, may generally be sized to extend over the outer edge, 418, of the second box, 41, and may be positioned to contact the outer edge, 418, of the second box, 41, thereby producing an outer edge that does not include a joint.

In some embodiments, such as the embodiment depicted in FIG. 4A, the upper edge, 408, may be composed of the insulating material layer of the first box, 40, and may include a cavity that is continuous with the cavity of the insulating material making up the side of the first box, 40. In other embodiments, the fold-over outer edge, 408, may be solid to provide a cap over the outer edge, 418, of the second box, 41, as illustrated in FIG. 4B or a portion of the fold-over outer edge, 408, may be solid as illustrated in FIG. 4C.

In still further embodiments, an insert may be formed that includes four adjoining sides that can be introduced into a box to provide a box having multilayer sides and a single layer base, or three multilayer sides and a multilayer base with one single layer side, or the like.

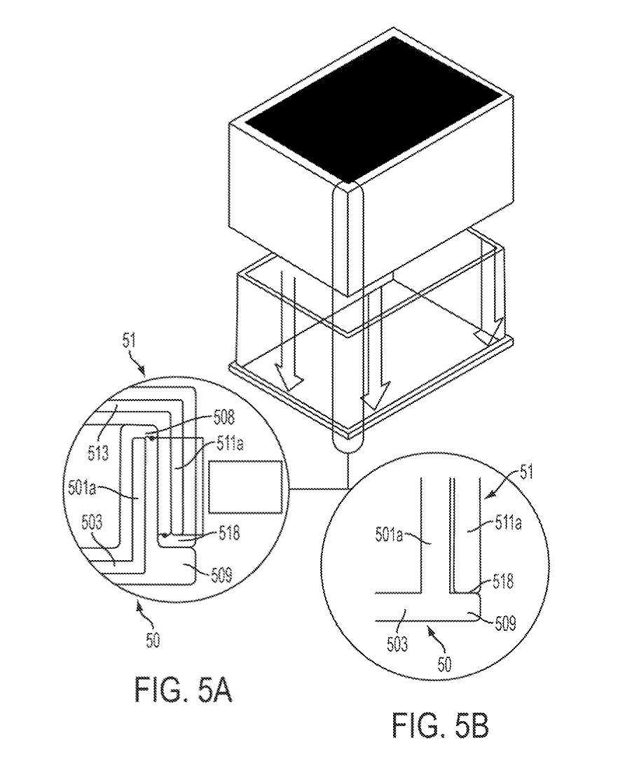

Some embodiments include a box in which all sides are enclosed. For example, as illustrated in FIG. 5A, in some embodiments, the first box, 50, may be configured to accept the second box, 51, such that the base, 503, of the first box, 50, and the base, 513, of the second box, 51, are opposed to one another. In this arrangement, the exterior, first material layer, 502, of the first box, 50, may contact the interior, second material layer, 518, of the second box, 51, such that these material layers are contiguous with one another. In an embodiment, a vacuum seal may be formed between the exterior of the first material layer, 502, and the interior of the second material layer, 518. Contact between the first material layer, 502, of the first box, 50, may contact the interior, second material layer, 516, of the second box, 51, may be maintained by friction or an adhesive layer provided between the adjoining material layers. In particular embodiments, the sides, 501a, of the first box, 50, and the sides, 511a, of the second box, 51, may be sized such that the outer edge, 508, of the first box, 50, contacts the base, 513, of the second box, 51, and the outer edge, 518, of the second box, 51, is continuous with the outer surface of the base, 503, of the first box, 50.

As shown in FIG. 5A, the interior of the sides, 501a, 511a, and/or bases, 503, 513, may include a cavity formed within double walls (for example, an interior wall and/or an exterior wall) of the sides and/or bases. The cavity may be a continuous cavity running from the sides through sides, 501a, 511a, and bases, 503, 513. In an embodiment, the cavities arranged with the interior of the sides, 501a, 511a, and/or bases, 503, 513 may be under vacuum. In this manner, an insulated container formed from the first box, 50, and the second box, 51, may be formed from double-walled containers having a vacuum cavity arranged within the double walls. According to some embodiments, the sides, 501a, 511a, and/or bases, 503, 513, including the double-walls (for instance, interior walls and/or an exterior walls of the sides and/or bases) may be formed from one piece such that there are no joints susceptible to a thermal leak.

In certain embodiments, as illustrated in FIG. 5B, an abutment, 509, may be formed on the first box, 50, and may be positioned to contact the outer edge, 518, of the second box, 51. The abutment, 509, may be continuous with the base, 503, of the first box, 50. As such the abutment can be integrated into the base, 503, and may include a cavity that is continuous with the cavity of the base, 503. In some embodiments, the abutment, 509, may include a cavity that is continuous with the cavity of the base, 503, or in other embodiments, the abutment may be solid. The sides of the first box, 50, and the second box, 51, may be sized such that the outer edge, 508, of the first box, 50, contacts an interior surface of the base, 513, of the second box, 51, and the outer edge, 518, of the second box, 51, contacts the abutment, 509. In some embodiments, the base, 503, of the first box, 50, and the base, 513, of the second box, 51, may include a second material layer (not shown) configured to provide a multilayer configuration on the bases 503, 513. According to some embodiments, each point of contact may be configured as a vacuum seal.

In some embodiments, insulated containers may include an insulated case assembly having an opening providing communication to a cavity disposed therein. In an embodiment, the insulated case assembly may include a cover attached to the insulated case assembly using a hinge or hinge assembly. The cover may be configured to move about the opening via the hinge and to close and seal the cavity, make the surface of the opening water tight and/or air tight, and to open and provide access to the cavity. In another embodiment, the insulated case assembly may include an opening configured to be sealed with a removable cover.

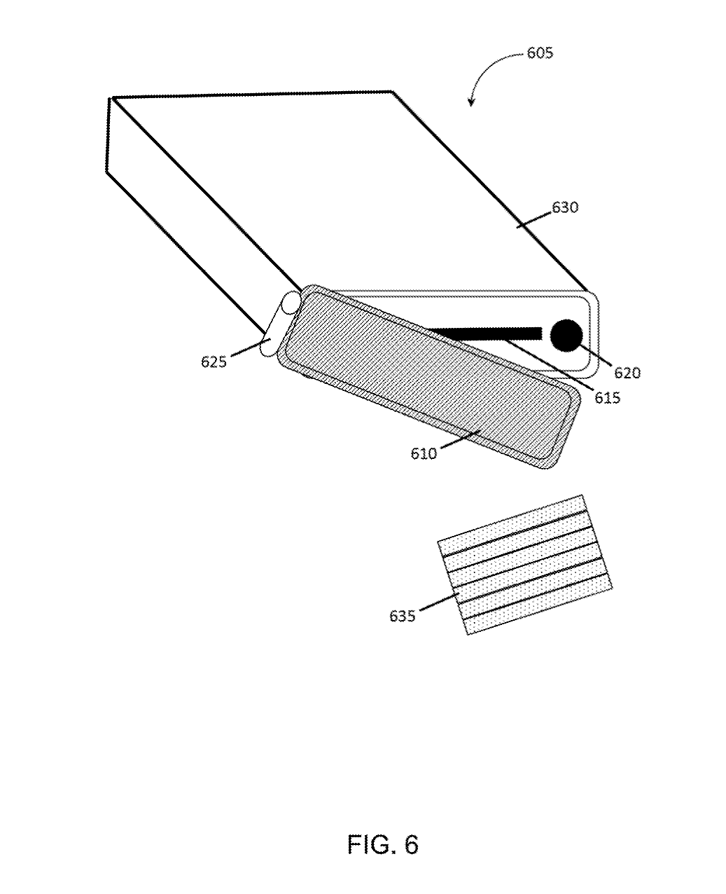

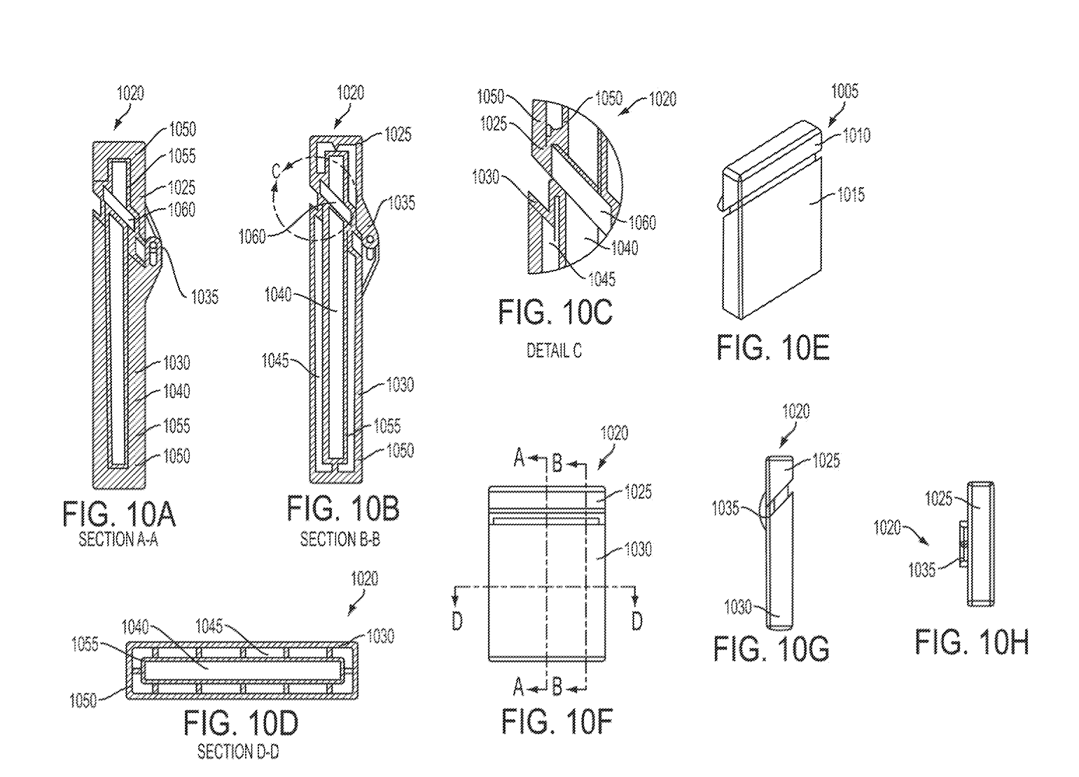

FIG. 6 depicts an illustrative insulated case assembly including a hinged cover according to some embodiments. As shown in FIG. 6, an insulated case assembly, 605, may include a case body, 630, having openings, 615 and 620, providing access to a cavity disposed within the insulated case assembly. A cover, 610, or door, may be attached to the case body, 630, using a hinge, 625, such that the cover may rotate about the openings, 615 and 620. The arrangement of the cover, 610, and the hinge, 625, may operate to allow the door to move into a closed position and an open position. In the closed position, the cover, 610, overlays, envelopes, surrounds, shrouds, or otherwise covers the openings, 615 and 620, and seals the cavity disposed within the insulated case assembly, 605. Some embodiments provide that the inside surface of the cover, 610, may include a gasket or similar structure configured to mate with the surface of the case body, 630, to form a water tight and/or gas tight seal. In the open position, the cover, 610, does not cover the opening, 615, such that the cavity disposed within the insulated case assembly, 605, is exposed. The cover, 610, may be insulated the same as or substantially the same as the insulated case assembly, 605 (see FIGS. 10A-10D).

The size and shape of the openings, 615 and 620, and the cavity may be configured according to various methods and/or purposes, such as for creating a vacuum within the cavity, as described herein, or for receiving an object or material. An illustrative and non-restrictive example provides that the opening, 615, and/or the cavity may be configured to receive a battery, electrical power source, electronic device, desiccant material, and/or a pellet strip.

In an embodiment, the pellet strip may be configured as one or more cells and may operate to generate energy in the form of heat. In this manner, the pellet strip may act as a power supply device, such as a battery. According to some embodiments, the heat generated by the pellet strip may cause the temperature inside of the insulated case assembly, 605, to be greater than about 350° C. In an embodiment, the heat generated by the pellet strip may cause the temperature inside of the insulated case assembly, 605, to be about 150° C., about 200° C., about 250° C., about 300° C., about 400° C., or about 500° C. In order to prevent a power loss, the insulated case assembly, 605, may be insulated in a manner that maximizes the power supply and has an outside touch temperature of less than about 45° C. so that it may be handled manually without the risk of causing burns or starting a fire.

In an embodiment, the opening, 620, may be configured as a port, for example, to facilitate an electronic or communication connection for a battery or electronic device contained within the cavity. In this manner, the insulated case assembly may include one or more openings, or ports, that allow for electronic connections to be made between components outside the container and components inside the container. The container may be configured to contain heat generated by the devices located in the container to reduce exposure of other components outside the container.

In an embodiment, the cover, 610, may include an opening (not shown) corresponding to the opening, 620, in the case body, 630, such that a connector (e.g., a connection terminal and, if necessary, wire or other electronic or communication conduit) may be inserted through the cover, 610, and connected to the battery, electrical power source, or electronic device located in the insulated case assembly 605. This opening may be configured such that the connector operates to seal the opening when the connector (and associated elements) is inserted therein. For example, the opening 620 may be associated with a gasket, the opening surface may by covered with a flexible sealing material, and/or the opening may be associated with a structure configured to mate with the connector in a manner that forms a seal.

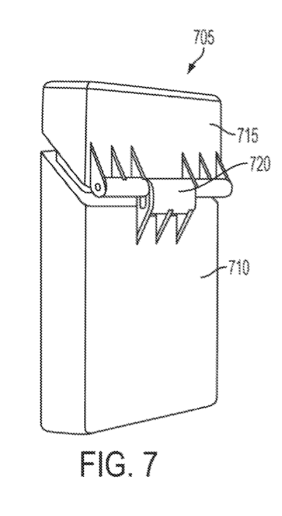

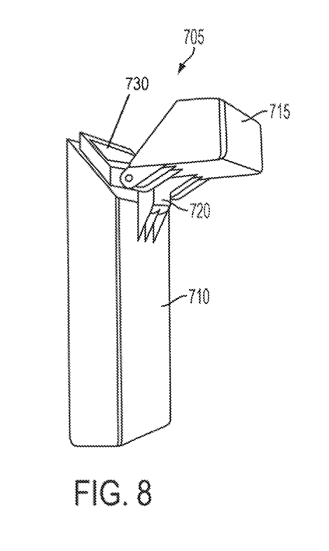

FIGS. 7 and 8 depict another illustrative insulated case assembly including a hinged cover in a closed position and in an open position, respectively, according to some embodiments. As shown in FIG. 7, a case assembly, 705, may include one or more cavities (not shown) disposed therein. The case assembly, 705, may comprise a cover, 715, connected to a case body, 710, via a hinge 720. In some embodiments, the hinge, 720, may be a slideable hinge including one or more knuckles having elongated grooves positioned to receive pins associated with the cover, 715. The elongated grooves may allow the pins to slide from a lower position when the cover is in an open position to an upper position while the cover is moved into place over the case assembly, 705. In an embodiment, the hinge, 720, may be slidable such that the cover may overlap the surface of the case body, 710, around the opening thereof by a prescribed margin. The cover may then be moved into closed position by action of the pins sliding to the lower position in the elongated grooves. In FIG. 7, the cover, 715, is in the closed position. The cover, 715, may be insulated the same as or substantially the same as the case assembly, 705.

In FIG. 8, the cover, 715, is in an open position, exposing an opening surface 725 configured to form an opening, 730, in the case assembly, 705, arranged to provide access to one or more cavities formed within the case assembly, 705. As shown in FIGS. 7 and 8, the cover, 715, may be configured as a door-like structure arranged to move about the opening, 730, of the case assembly, 705, in one of an open position and a closed position. In an embodiment, the inside surface of the cover, 715, may comprise a sealing structure, such as a gasket, stopper, overlap, offset, or seal configured to provide a water tight, gas tight and/or vacuum seal for the case assembly, 705, when the cover, 715, is in the closed position. For instance, the inside surface of the cover, 715, may include a gasket comprised of an inert flexible material configured to mate with the opening, 730, and/or the opening surface, 725. In another instance, the cover, 715, may include an offset around the edge of the opening, 730, configured to provide a vacuum sealed wall or surface, in which the offset overlaps an outer surface of the opening and/or the case assembly, 705.

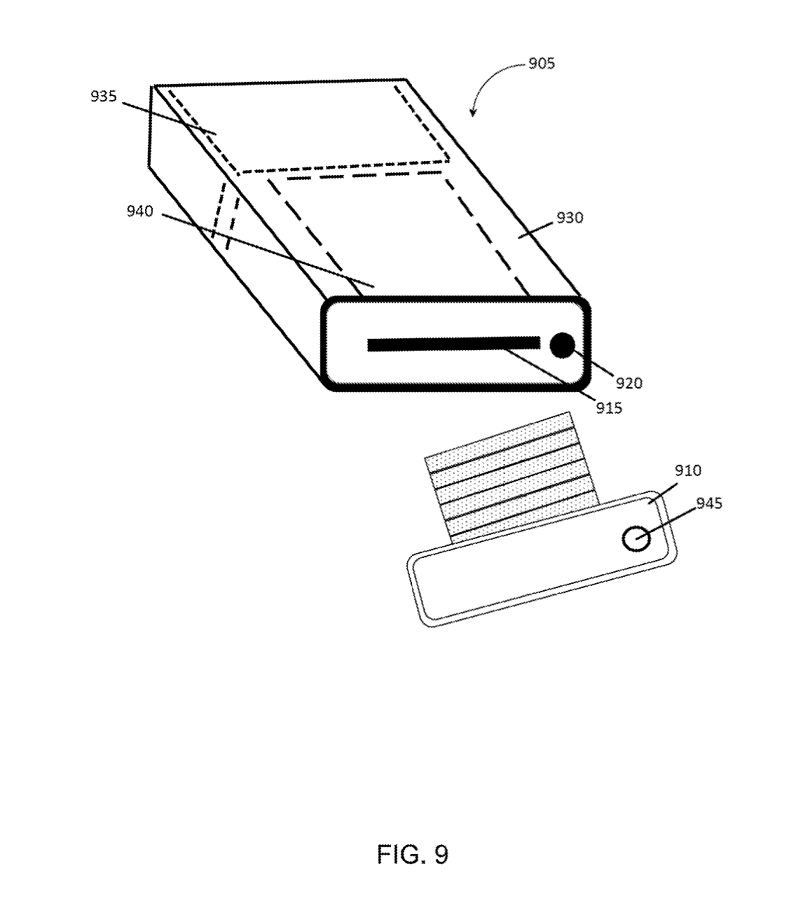

FIG. 9 depicts an illustrative insulated case assembly including a removable cover according to some embodiments. As shown in FIG. 9, an insulated case assembly, 905, may include a case body, 930, comprising openings, 915 and 920, providing access to a cavity disposed within the insulated case assembly. A cover, 910, may be formed to mate with the case body, 930, in a manner that covers one or both of the openings, 915 and 920. The cover, 910, may be insulated the same or substantially the same as the insulated case assembly, 905.

The cover, 910, and the case body, 930, may be arranged in a closed position and an open position. In a closed position, the cover, 910, may be connected to the case body, 930. In an open position, the cover, 910, may be disconnected from the case body, 930. In the closed position, the cover, 910, may overlay, envelope, surround, shroud, or otherwise cover one or more of the openings, 915 and 920, and at least partially seal the cavity disposed within the insulated case assembly, 905. Some embodiments provide that the inside surface of the cover, 910, may include a gasket or similar structure configured to mate with the surface of the case body, 930, to form a water tight and/or gas tight seal. In the open position, the cover, 910, does not cover the opening, 915, and the cavity disposed within the insulated case assembly, 905, is exposed. In an embodiment, the surface surrounding one or more of the openings, 915 and 920, may be formed as a neck, flange, gasket, or other structure configured to mate with a corresponding formation on the inside of the cover, 910. For example, the surface surrounding one or more of the openings, 915 and 920, may be configured as a neck and the cover, 910, may be configured to slide over the neck to place the cover, 910, and the case body, 930, in the closed position.

According to some embodiments, the surface of the cover, 910, that interfaces with the case body, 930, may have a structure, 925, attached thereto. The structure, 925, may be configured for insertion through one or more of the openings, 915 and 920, when the cover is attached to the case body, 930. For example, the structure, 925, may include a battery, electrical power source, electronic device, pellet strip (described in more detail below), or a cartridge associated with one or more materials (e.g., desiccant).

In an embodiment, the opening, 920, may be configured as a port, for example, to facilitate an electronic or communication connection for a battery, electrical power source or electronic device contained within the cavity. In this manner, the insulated case assembly may include one or more openings, or ports, that allow for electronic connections to be made between components outside the container and components inside the container. The container may be configured to contain heat generated by the devices within the container, for example, to reduce exposure of other components outside the container.

In an embodiment, the cover, 910, may comprise an opening, 945, corresponding to the opening, 920, in the case body, 930, such that a connector (e.g., a connection terminal and, if necessary, wire or other electronic or communication conduit) may be inserted through the cover, 910, and connect to the battery, electrical power source or electronic device located in the insulated case assembly 905. The opening, 920, may be configured such that the connector operates to seal the opening when inserted therein. For example, the opening, 920, may be associated with a gasket, the opening surface may by covered with a flexible sealing material, and/or the opening may be associated with a structure configured to mate with the connector in a manner that forms a seal.

In an embodiment, the cavity arranged within the insulated case assembly, 905, may be divided into separate segments. For example, the cavity may be divided into one or more insulated segments, 940, and one or more non-insulated segments, 935. According to some embodiments, the separate segments may be designed for different purposes. In one example, the insulated segments, 940, may be configured to house one type of object or material, while the non-insulated segments, 935, may be configured to house a different type of object or material. In another example, one of the segments, 935 and 940, may remain empty (e.g., under vacuum), while another is configured to house an object or material (e.g., under vacuum).

FIGS. 10A-10H depict an illustrative insulated case assembly according to some embodiments. In general, FIGS. 10E, 10F, 10G, and 10H depict various views of an illustrative insulated case assembly according to some embodiments, while FIGS. 10A, 10B, 10C, and 10D depict various cross-sectional views or detailed views of the insulated case assembly depicted in FIG. 10F.

In FIG. 10E, therein is depicted an illustrative insulated case assembly, 1005, comprising a cover, 1010, enclosing an opening formed in a case body, 1015. Referring to FIG. 10F, therein is depicted an illustrative insulated case assembly, 1020, comprising a cover, 1025, enclosing an opening formed in a case body, 1030. FIGS. 10A, 10B, and 10D depict views of the insulated case assembly, 1020, along sections A-A, B-B, and D-D, respectively. FIG. 10C depicts a detailed view of detail C in FIG. 10B.

For example, FIG. 10A depicts insulated case assembly, 1020, along section A-A. In FIG. 10A, the cover, 1025, is attached to the case body, 1030, via a hinge, 1035, and in some embodiments, the hinge may include the elongated groove structure described above. The insulated case assembly, 1020, may include a first structural material, 1050, forming the case body, 1030, and a second structural material, 1055, forming an inner cavity, 1040, within the insulated case assembly, 1020. Some embodiments provide that the inner cavity, 1040, may be configured to hold one or more objects (e.g., batteries, electronic power source, electronic devices, etc.) and/or materials (e.g., chemicals, desiccant) and/or to sustain a vacuum, for instance, for insulation purposes.

In an embodiment, one or more of the cavities, 1040 and/or 1045, may be filled with a low-conductivity material and the cavities placed under various levels of vacuum, for instance, to provide an insulator. Illustrative low-conductivity materials include, without limitation, glass fibers and fumed silica. Non-restrictive examples of the various levels of vacuum may include no vacuum, partial vacuum, complete vacuum (or substantially full vacuum), and levels of vacuum in between.

The first structural material, 1050, may be configured to form a plurality of outer cavities, 1045. According to some embodiments, the plurality of outer cavities, 1045, may be configured to provide insulation for the insulated case assembly, 1020. In an embodiment, the plurality of outer cavities, 1045, may be placed under vacuum and/or hold desiccant placed therein.

As shown in detail in FIG. 10C, the cover, 1025, may include a stopper, 1060, configured to form a seal between the cover and the case body, 1030b. As depicted in FIG. 10D, the plurality of outer cavities, 1045, may comprise similarly sized cavities that are spaced evenly apart and encircle the inner cavity, 1040. In an embodiment, the outer edges of the plurality of outer cavities, 1045, may be configured as ribs that are tapered to a point. As depicted in FIGS. 10A-10D, the case body, 1030, may comprise a double-wall structure and the cover, 1025, may also include a double-wall structure configured to seal the case body and the cavities, 1040 and/or 1045, formed therein. This particular formation may operate to prevent thermal leakage for the insulated case assembly, 1020. FIG. 10G provides a side view of the insulated case assembly, 1020, while FIG. 10H provides a top-down view of the insulated case assembly.

According to some embodiments, the length of the insulated case assembly, 1020, may be from about 2 inches to about 6 inches, the depth may be from about 1.9 inches to about 3.9 inches, and the width may be from about 1.5 inches to about 3.5 inches. Some embodiments provide that the first structural material, 1050, may be about 0.06 inches thick, and the second structural material, 1055, may be about 0.02 inches in thick.

With respect to the containers described above, such as in FIG. 2, FIG. 3, and FIG. 5A, embodiments depicted in FIGS. 6-9 and FIGS. 10A-10H may be formed to have a thinner profile. However, embodiments described herein are not limited to one or a restricted range of profiles. The embodiments described herein, including those depicted in FIG. 2, FIG. 3, and FIG. 5A may be formed of shapes, profiles, and sizes capable of operating according to the embodiments.

The containers, boxes, containers, cases, cartridges, and the like, of various embodiments described above, including those with an open end and those with enclosed ends, can include any number of additional insulating layers, and the additional insulating layers may be composed of any material. For example, in some embodiments, the additional insulating layers may be composed of, for example, the insulating material defined and described with regard to FIG. 1, fiber glass, polystyrene, polyurethane, urea formaldehyde, phenolic or styrene foams, polyisocyanurate, structured polymer or fiber films such as those described in, aerogels, fumed silica, polyurethane, or combinations thereof. An additional insulating layer may be provided on an interior or exterior surface of any of the boxes described above, or an additional insulating layer may be added as an intermediate layer between contiguous sides of a multilayer box. For example, in certain embodiments, an additional insulating material may be incorporated into an adhesive that forms an intermediate/adhesive layer between the sides of a multilayer box or between a base and the second material layer for the base.

Although five- and six-sided boxes are described above, embodiments are not so limited as various embodiments may include containers that are circular, cylindrical, or conical shaped and containers having any number of sides to form triangular, pentagonal, hexagonal, heptagonal, octagonal, elliptical, oval, lobe-shaped, and like or similar shaped containers. Such containers may generally have a similar structural arrangement of insulating layers.

In certain embodiments, the containers described above may include any number of openings through one or more sides or the base of the containers of various embodiments. The openings can be formed during construction of the container such that the surface of the opening is consistent with the first structural material and the second structural material thereby sealing the cavity and making the surface of the opening airtight. Generally, the openings may provide a means for communicating between the interior and exterior of the container. In some embodiments, the openings may provide a means for attaching the container to a surface, and/or a means for allowing air flow through the interior of the container.

In various embodiments described above, the insulating material can be characterized as having an open cell structure. The term “open cell”, as used herein, refers to a structure having a series of channels and interconnected passageways that define a substantially open configuration. Insulating materials such as those described above with reference FIG. 1 having projections 104a, 104b, separating the first material layer, 103, and the second material layer, 106, that maintain a cavity, 108, are exemplary of open cell structures.

According to some embodiments, the cavities may form a disruptive thermal conduction matrix so that thermal conduction within the insulating material device is reduced with respect to other materials. These insulating materials may be configured to reduce conduction and convection of heat through the material by reducing contact points between the first material layer, 102, and the second material layer, 106. Therefore, in some embodiments, the number of projections may be minimized to maximize the volume of the cavity, thereby providing maximum thermal resistance. As such, in certain embodiments, the insulating material may include a cavity encompassing at least 40% of the total volume of the insulating material, and in other embodiments the cavity may encompass at least about 45%, at least about 50%, at least about 55%, at least about 60%, at least about 70%, or at least about 75% of the total volume of the insulating material.

The projections 104a, 104b, illustrated in FIG. 1, may have any shape that allows for the creation of the cavities within each layer of insulating material. For example, in some embodiments, the projections may have a lenticular shape, an accordion shape, or a post shape wherein each post can have a cross-sectional shape that is t-shaped, u-shaped, square, rectangular, or any irregular or regular polyhedron and the like, circles, hooks, ellipses and the like, and any combination of these. The posts are not limited by shape and can be any shape known in the art, such as, for example, rectangular or square. The cross-section of these posts, for example, trapezoidal or the like, may be any shape, including curved, such that these shapes provide sufficient structural support while creating a large volume region. This structure arrangement is similar to the lenticular projection structure except that the lenticular projections are periodically interrupted, the equivalent of crossed-lenticular projections, where a square post results if the periodicity is the same in orthogonal directions, or a rectangular post results if the periodicity is different in orthogonal directions. In some embodiments, one or both layers of insulating material may include projections that are the same shape, and in other embodiments, one or both layers of the insulating material may include projections of different shapes.

In certain embodiments, the portion of the structure extending from the structural material layer may be larger at the base than at the tip to provide a tapered extension. For instance, a tapered configuration may provide increased structural strength as pressure is lowered, may remove mass from the insulating material, and/or may increase the thermal resistance in the insulating material. In various embodiments, about 1% or less of the total surface area of an extension from a first layer may contact a surface of a second layer, and in other embodiments, less than about 0.9%, less than about 0.8%, less than about 0.7% or less than about 0.5% of the total surface area of an extension may contact a surface of a second layer.

In some embodiments, one or more layers of insulating material may include cavities that extend through multiple layers or may be present only within an outermost layer or stratum of the insulating material. For example, in some embodiments, the projections may have an accordion-like cross-sectional shape in which cavities are created within the accordion like projections that extend from an edge of the insulating material to an opposite edge of the insulating material. In certain embodiments, the insulating material may be made up of a first material layer having accordion-like projections and a second material layer having accordion-like projections. The cavities of the accordion-like projections from the first material layer and the second material layer may be arranged such that they are substantially perpendicular to one another. In other embodiments, the cavities may be non-intersecting. In still further embodiments, accordion-like projections extending from a first material layer may be orthogonal to accordion-like projections extending from a second material layer. In yet other embodiments, accordion-like projections from a first material layer and accordion-like projections from a second material layer may be at an angle such as about 25°, about 30°, about 45°, about 60°, or about 90° relative to one another.

These projections may be positioned in various ways. For example, in some embodiments, the projections may extend from a first structural material and may be equally or irregularly spaced on the first structural material. In some embodiments, a second structural material may have projections, and a surface of the second structural material may contact the projections from the first structural material directly. In other embodiments, the second structural material may have projections that are configured to contact a surface of the first material layer or projections from the first material layer. In still other embodiments, the first structural material may have projections extending from both an upper and a lower surface, and substantially planar second material layers may be positioned to contact the projections extending from one or both surfaces. Such an arrangement may provide two cavities, one on either side of the first material layer. In yet further embodiments, a substantially planar first material layer may be contacted on an upper and a lower surface by projections associated with upper and lower second material layers. As above, this arrangement may provide two cavities, one on either side of the first material layer.

Multiple layers can be provided by any of the means described above or combinations of these means to produce materials having multiple cavities. In some embodiments, the number of projections may be minimized, by, for example, increasing periodicity/spacing between posts. Increasing periodic interruptions result in increased spacing between the posts, which maximizes the vacuum area, thereby maximizing the thermal resistance of the material. For example, in embodiments where the two layers are placed so that the projections are parallel, the thermal resistance may be approximated by a cylindrical thermal conductor. In some embodiments, two layers my be placed such that the projections are orthogonal to each other, thereby providing a relatively higher thermal resistance than when the projections are in the parallel configuration. In such embodiments where the projections are orthogonal, the thermal resistance may be approximated by a spherical thermal conductor.

Analytical models for thermal resistance may be applied for cylindrical and spherical thermal conductors, respectively. For example, the structures may be analyzed as indentations in a thermally resistant material that are turned into vacuum areas, in the shape of or substantially in the shape of an isosceles trapezoid. The lenticular projection structures between the vacuum areas have a width (B) at the base of the projection, an angle of 90°+0 at the tip of the projection having a width (b), and height (H) of the projection. The isosceles triangle region may be assumed to be a vacuum and all thermal losses may be assumed to occur by conduction through the thermally resistant material containing the indentations. Thermal flow in the indentions may be limited due to the vacuum in that region. The effective thermal resistance of the vacuum region may be considered sufficiently large so that the effective thermal resistance of the insulating material may be equated to that of the thermal resistance of the material region alone, the region containing the structures. For example, if the thermal resistance of the vacuum region is ten times that of the material region, the thermal resistance of the combination is lowered by just 9% compared to the material region alone.

According to analytical models for thermal resistance in insulated containers configured according to some embodiments, a single layer has indentations on one side only, with the other side being smooth. The thickness of the layer may be defined as (t). In some embodiments, the insulating material may have at least two such layers, where the second layer may be a mirror image of the first layer, with two possible configurations as discussed above for the second layer, parallel and orthogonal. For example, in some embodiments, the lenticular projections of the second layer may be parallel to the lenticular projections of the first layer with the insulating material being approximated by a radial flow of heat between two coaxial cylinders. Alternatively, the lenticular projections of the second layer may be placed orthogonal to the lenticular projections of the first layer with the insulating material being approximated by a radial flow of heat between two concentric spheres.

In an embodiment, the thermal resistance of an insulating material device with two layers can be approximated as twice that of a single layer (R_{EFF}). Furthermore, the number (N) of insulating material devices each having two layers may be stacked and the stack would have a thermal resistance (N) times that of a single device. The separation between isosceles triangles can be approximated by a section of the circumference of a circle of radius (r₁) and angular size (q). The radius (r₁) is derived below in terms of the structure parameters. The flow of heat can be represented approximately as radial flow along the sides of the isosceles triangle of angular size (q). The heat flows out to a radius defined as (r₂), derived below as a function of the structure parameters. Once the heat expands past the apex of the isosceles triangle, any heat flowing out from the structure laterally will be replenished by heat flowing in from adjacent structures.

The effective thermal resistance of a single layer is related to the effective thermal conductivity (k_{EFF}) and thickness (t) of the layer by:

R_{EFF}=t/k_{EFF} (1)

The effective thermal conductivity for an insulating material containing layers having parallel projections can be approximated from the thermal conductivity equation for concentric cylinders. This includes physical properties of the layer. The equation is given by:

dQ/dt=−k(θπ/180)rLdT/dr (2)

where

L=length of the layer whose cross-section is an isosceles triangle

dQ/dt=rate of flow of heat

k=thermal conductivity of the material of the layer

r=radial direction of the heat flow

dT/dr=gradient of temperature in the radial direction

The integral can be written as:

(dQ/dt)∫(dr/r)=−k(θπ/180)L∫dT (3),

where the limits on the radial integral are between r₁ and r₂, and the limits on the temperature integral are between the internal temperature (T₁) and the temperature at the middle of the first layer with an outside temperature of T_{O} [(T_{O}+T₁)/2n]. Although it is assumed that the interior temperature will not change, this will not affect the calculation of the effective thermal resistance (R_{EFF}) of the single layer, which is a physical parameter of the system.

This integral equation may yield:

dQ/dt=k(θπ/180)[ln(r₂/r₁)]¹L{T₁−[(T_{O}+T₁)/2n]} (4)

From equation (4) it may be determined that the term between the equal sign and (L) is k_{EFF}, which includes the effects of the structural parameters and thermal conductivity of the material.

k_{EFF}=k(θπ/180)[ln(r₂/r₁)]⁻¹ (5)

Equation (5) can be substituted into equation (1) to yield the effective thermal resistance (R_{EFF}):

R_{EFF}=t ln(r₂/r₁)[k(θπ/180)]⁻¹ (6)

The parameters of the system (θ, r₁, r₂) may be calculated in terms of the known structure parameters of the device. Based on geometry, the parameters can be derived to be:

θ=2 tan⁻¹(B/2H) (7)

r₁=(b/2)[1+(4H²/B²)]^{1/2} (8)

r₂=H[1+(B²/4H²)]^{1/2}+(b/2)[1+(4H²/B²)]^{1/2} (9)

The value of k_{EFF} for an insulating material containing orthogonal projections in the layers can be approximated from the thermal conductivity equation for concentric spheres. This approximation includes physical properties of the layer. The equation may be given by:

dQ/dt=−k2π(L/t)(1−cos θ)r²dT/dr (10)

where
L=length of the layer, which is equal to the thickness (t) for a device that is represented by concentric spheres
dQ/dt=rate of flow of heat
k=thermal conductivity of the material of the layer
r=radial direction of the heat flow
dT/dr=gradient of temperature in the radial direction.

The integral may be written as:

(dQ/dt)∫(dr/r²)=−k2π(L/t)(1−cos θ)∫dT (11),

where the limits on the radial integral are between r₁ and r₂, and the limits on the temperature integral are between the internal temperature (T₁) and the temperature at the middle of the first layer with an outside temperature of T_{O}[(T_{O}+T₁)/2n]. It is assumed that the interior temperature will not change, although any change in temperature will not affect the calculation of the R_{EFF} of the single layer, which is a physical parameter of the system. This integral equation can be solved to yield:

dQ/dt=k2π(1−cos θ){r₁r₂/[(r₂−r₁)t]}L{T₁−[(T_{O}+T₁)/2]} (12)

From equation (12) it may be determined, as in equation (4), that the term between the equal sign and L is k_{EFF}, which contains the effects of the structural parameters and thermal conductivity of the material.

k_{EFF}=k2π(1−cos θ){r₁r₂/[(r₂−r₁)t]} (13).

Equation (13) can be substituted into equation (1) to yield the effective thermal resistance (R_{EFF}):

R_{EFF}=t{k2π(1−cos θ){r₁r₂/[(r₂−r₁)t]}⁻¹ (14).

The parameters of the system (θ, r₁, r₂) may be calculated based on the structure parameters of the device in equations (7), (8) and (9) above.

The insulating material of embodiments includes at least one layer, and preferably, at least two layers. In some embodiments, each layer may have a thickness of about 0.01 mm to 1 mm. The configuration of at least two layers of insulating material forms a stratum of insulating material. As used herein, the term “stratum” may refer to layers of material where at least one portion of one layer is arranged on top of at least one portion of another layer. In some embodiments, the insulating material device includes one stratum, but other embodiments may include multiple strata. In some embodiments, each layer comprising the stratum may be about 10 μm to about 1000 μm thick. In certain embodiments, each layer comprising a stratum may be about 100 μm thick. In other embodiments, the insulating material device may have a thickness of about 0.1 mm to about 10 mm. In yet other embodiments, the device may have a thickness of about 5 mm.

The number of strata in an insulating material device determines the thermal resistance (R) value of the insulator. The R value of a stratum may be determined based on the geometry of the layer(s), the thermal conductivity of the material making up the layer(s), the vacuum pressure, and ratio of the volume of the material of the layer(s) to the volume of the vacuum. Increasing the spacing between protuberances increases the ratio of the vacuum to the volume of the material of the layer(s). Reducing the projection height reduces the height of the vacuum region. Depending on the vacuum pressure, this could lead to fewer collisions between molecules in the vacuum region and allow higher pressure for a given thermal resistance. Thus, higher vacuum pressures may be utilized to obtain a given thermal resistance to make the insulating material easier to manufacture and enable mass production of flexible vacuum insulation panels. Additionally, in certain embodiments, if a predetermined R value is desired, the number of stratum necessary to achieve the desired R can be calculated. The insulating material device may have an R value from about 2.5 to about 25 in units of K-m²/W. In some embodiments where relatively thinner layers are utilized, the R value may be even higher as thinner layers allow for more stratum for a given device thickness.

To increase the thermal resistance of the stratum, other intermediate layers may be inserted between or positioned at an angle to the existing layers of a stratum. In some embodiments, the intermediate layer may include a substrate having at least one structure. The intermediate layer material may be any polymer, ceramic or composite material consistent with the end application. In some embodiments, the intermediate layer is of a specific design that minimizes the volume of the intermediate layer material relative to its vacuum volume and minimizes the contact area to the layers above and below it, thereby reducing thermal conduction through the material of these layers. One non-limiting example of an intermediate layer design that simultaneously maximizes vacuum area while providing structural support is a thin accordion-like structure. The top of the triangular structure of the accordion may be made to a pre-determined width so that the contact area to the surfaces above and below may be controlled. A dual intermediate layer design may be used where the projections are placed orthogonal to each other to maximize thermal resistance and structural strength when a vacuum is drawn.

In some embodiments, the shape of at least one structure of a second ceramic or polymer layer may be the same as the shape of at least one structure of a first ceramic or polymer layer. The structure of the second ceramic or polymer layer may be rotated and angled differently than the structure of the first ceramic or polymer layer. In other embodiments, the structure of the second ceramic or polymer layer may be different than the shape of the structure of the first ceramic or polymer layer. In particular embodiments, the second ceramic or polymer layer may be positioned over the first ceramic or polymer layer with the corresponding structures touching. In others, the second ceramic or polymer layer may be positioned over the first ceramic or polymer layer with the corresponding substrates touching.

In further embodiments, the structure periodicity per layer may differ, so that the layers of the stratum are effectively staggered to minimize the thermally conductive path and maximize the thermal resistance. In certain embodiments, an insulating material device may include at least two stratum where one stratum may have a different set of periodicities than the second stratum. Alternatively, the two strata may have the same set of periodicities, but one stratum may be offset or staggered from the second stratum. In addition, the orthogonal configuration of two layers of insulating material may form a rigid structure, so in certain embodiments, in order to impart flexibility to the insulating material, internal breakpoints of each layer may be aligned to each other.

The insulating material may be formed of a variety of structural materials and/or layers that make up the structural material layers including, but not limited to, metals, polymers, ceramics, composites, high temperature composites, carbon fiber, and reflective materials, and in some embodiments, the structural material may be thermally insulating. Non-limiting examples of ceramic layer materials include mullite, soda-lime glass, borosilicate, and zirconia to name a few. When the insulating material is formed from a polymer, an opaque material with a low thermal conductivity may be used. Among the numerous polymers which may be used in accordance with the embodiments described herein, the following may be mentioned as non-limiting examples: polystyrene, polyvinyl chloride, polyethylene, polypropylene, polyacrylonitrile, polybutadiene, polyisoprene, polytetrafluoroethylene, polyesters, melamine, urea, phenol resins, silicate resins, polyacetal resins, polyepoxides, polyhydantoins, polyureas, polyethers, polyurethanes, polyisocyanurates, polyimides, polyamides, polysulphones, polycarbonates, copolymers, and mixtures thereof.

In particular embodiments, one or more structural material layer may be composed of a moisture barrier material. Such moisture barrier materials are known in the art and any such material may be used in embodiments described herein. In some exemplary embodiments, the moisture barrier material may be a composite of a polymeric material such as, for example, polyesters, polycarbonates, polyarylites, polyphenylene sulfide, polycycloaliphatics, polyacrylates, polystyrenes, polyurethanes, polyolefins, cellulose-based films, and the like, or thermoplastic materials such as, for example, resinolyvinyl acetates, polybuterates, polyolefin, polyacrylates, polyurethanes, epoxy polymers, polyesters, polycarbonates, polycycloaliphatics, polyvinyl ethers, polyvinyl alcohols, silicones, fluorosilicone polymers, rubbers, ionic polymers, and the like, and nanoparticles including materials such as, but not limited to, alumina, silica, mica, silver, indium, nickel, gold, aluminum suboxide, aluminum oxynitride, silicon suboxide, silicon carbide, silicon oxynitride, indium zinc oxide, indium tin oxide, calcium chloride, calcium sulfate, phosphorus pentoxide, or other water-retaining polymers, or the like, and various combinations thereof.

In certain embodiments, one or more material layers of the insulating material, which may or may not include projections, may further include a component that acts to effectively block UV, visible and/or IR radiation. For example, in some embodiments, the component may be a reflective material or coating that acts to reflect heat or other radiation before being absorbed by the insulating material. In other embodiments, the component may be a pigment that can be provided in a material layer or a coating that absorbs particular types of radiation that may affect the insulating material. For example, one or more material layers may include additives such as, but not limited to, colorants, UV stabilizers, preservatives, degassing agents, strengthening agents, antioxidants, fillers, adhesives, thickeners, and the like and various combinations of these.

Between any two layers, or one per stratum, there may be one or more layers of highly reflecting material or surface reflective material where the reflectivity might be specular or diffuse. In other embodiments, the ceramic or polymer layer may include a surface reflective material. As used herein, the term “highly reflective” means in excess of about 80%. The highly reflective material may include metal foil or metalized film. Non-limiting examples include aluminum foil, gold foil and aluminized or double aluminized MYLAR® (polyethylene terephthalate) film (MYLAR® is a trademark of E.I. Du Pont De Nemours and Company, Delaware, USA). In other embodiments, the highly reflecting material may include a dielectric material, such as, for example, titanium dioxide. In particular embodiments, the reflective material layer includes a single layer of highly reflective material. In other embodiments, the reflective material layer comprises a multilayer stack of highly reflective material.

In some embodiments, the highly reflective material layer will have a thickness of about 0.025 μm to about 10 μm. Thickness values of about 0.025 μm to about 1 μm are common for metal foils while values of about 1 μm to about 10 μm are common for metalized films. In preferred embodiments, the highly reflective material layer will have a thickness of less than or equal to about 1.0 μm. The presence of the highly reflective material increases thermal resistance by reducing the thickness of the vacuum region so that the mean free path of remaining particles in the vacuum is closer to the vacuum thickness and the reflective material reflects the infrared. In some embodiments, a reflective material coating may be applied to a portion of the structures, such as projections, to prevent or minimize radiation through each layer. In some embodiments, each side or the face of the structures are coated with a reflective metal, meaning that each stratum may contain four metalized surfaces. In some multilayer embodiments, the surface reflective material of a first ceramic or polymer layer may face the surface reflective material of a second ceramic or polymer layer.

In some embodiments, the stratum may be contained in a protective polymer coating that enables and protects the vacuum and is made with or without a reflective surface. In certain embodiments, the stratum may be contained in a polymer pouch or jacket that can sustain a vacuum panel from about 6 months to about 50 years. In some embodiments, the pouch may include a multilayered structure that includes gas and/or moisture barriers per layer, nano-coating material, as well as heat seal layers.

The gas and/or moisture barrier layers may contain thin (about 30 to 60 nm) layers of vacuum deposited materials, such as, for example, aluminum, which may provide a physical impermeable barrier to gas diffusion as well as act as a reflector to radiation. The material used in the barrier layer may contain one or more structures on either or both sides of the barrier layer. If the barrier layer has one side that is external, the one or more structures may be on both the internal and external sides. A desiccant layer, which may also act as a moisture barrier, may also be added and regenerated by vacuum deposition using one or more vacuum chambers. Additionally, the gas and/or moisture barrier layers may contain organic materials such as, for example, polyvinylidene chloride (PVdC), ethylene vinyl alcohol (EVOH), or polyvinyl alcohol (PVOH) to intensify the gas barrier properties. In yet other embodiments, the temperature may be engineered to fluctuate in a cyclical manner to promote degassing, and a cyclical pulsating movement may be added to encourage molecule movement in layers while multiple stratum are degassed. Other materials, such as, for example, nano-sized aluminum oxide, can be used as a surface coating that acts as a getter.

After the stratum are placed in the pouch or jacket, in some embodiments, inert gas, such as argon or xenon, may be pumped into the pouch to replace the ambient air before the vacuum is pulled and the pouch is sealed. This improves the thermal resistance of the insulating material device because the thermal conductivity of the argon and xenon is relatively lower than that of ambient air. In another embodiment, the stratum is dried at 50° C. to 90° C. prior to be held under vacuum. The level of vacuum required varies based on a number of factors including, but not limited to, the desired application, structure, design and configuration of layers, number of layers, and the insulating value (R) required. In various embodiments, the near vacuum pressure is about 10⁻⁶ bar or less, and in certain embodiments, the level of vacuum required may range from about 10⁻³ bar to about 10⁻⁶ bar. In certain embodiments, a double or multiple chamber assembly system is utilized whereby the strata and the protective polymer barrier coating are degassed simultaneously and the pressure is lowered separately. Degassing can occur using baking either prior to or while under vacuum, or possibly both to achieve the best effect.

In certain embodiments, pouch closure may be accomplished via heat sealing using high-density polyethylene (HDPE), oriented polypropylene (OPP), cast polypropylene (CPP), or amorphous polyethylene terephthalate (A-PET).

The insulating material may be fabricated by any method utilized in the industry as appreciated by one skilled in the art, including, but not limited to, injection molding and/or micro replication techniques. In one embodiment, a master mold may be machined with the desired structures. The master mold may be diamond turned, laser etched or chemically etched, depending on, for example, the size of the features of the structures. The structures may then be formed via embossing (thermal), cast and cure (UV initiated), or other injection molding techniques. A web-based roll process or other roll process may be utilized. In certain embodiments, the roll process operates initially, at lines speeds of about 30 to 50 m min⁻¹. The resulting sheet may be up to two meters wide and may be customized to desired lengths and widths. In some embodiments, the sheets may be manipulated using an automated process and placed into a polymer jacket, with the jacket atmosphere enhanced with a gas, such as, for example, argon or xenon, before being placed under vacuum.

In some embodiments, additional hot sealing techniques may be used post vacuum sealing to add a cell-like sealing matrix. This is preferable in applications, such as, for example, where there is a potential for the insulating material device to be punctured, thereby minimizing the insulating effects.

The insulating material and containers made from these insulating materials may be utilized to insulate any object. In some embodiments, the containers including insulating material may be utilized to aid in maintaining the temperature of items at a desired temperature. In other embodiments, the containers including insulating material described herein may prevent heat loss from an item. Examples of applications include, but are not limited to, food packaging, beverage cans, bottles, flexible beverage pouches, insulation of power transmission cables and equipment, electronic devices, various electrical power sources, transfer and transportation systems for liquid cryogens, heat pipes, heat pumps, space launch vehicle propellant tanks and feed lines, refrigeration units, appliances, medical packaging (e.g., for vaccines), medical transportation boxes, containers of any type, transfer and transportation of carbon dioxide, ammonia, chilled water or brine, oil and steam, and residential applications such as lining of woodboards, plasterboards, roof insulation, vacuum insulated material, and the like and other building materials such as, flooring, sub-flooring, tiles, dry wall insulating composites, and the like. According to some embodiments, the insulated container may be integrated into any component configuration, where the outside of the insulating container may be constructed of a material and coated/covered with another material to provide the final finished designed. For example, the insulating container may be integrated into a stainless steel refrigerator in which the outer surface of the insulating container is at least partially coated and/or covered in the stainless steel material. In another example, the outer surface of the insulating container may be covered with various aesthetically appealing materials, such as leather, configured to correspond with the end product using the insulating container.

In some embodiments, the insulating material device may be a component of a container such as, for example, a metal container having a double wall. For example, the insulating material may be formed into the shape of a cylinder corresponding to the shape of a double wall metal beverage container and be utilized to insulate the contents of such container. In some embodiments, the insulating material may have a wall thickness of less than about 2 mm and may be placed in between the two walls of the double wall beverage container. The double wall container may then be sealed. As understood by one skilled in the art, the double wall beverage container may be vacuum sealed or in alternative embodiments may not be vacuum sealed and merely sealed to protect the contents located therein.

In some embodiments, the containers described above may be useful for holding electronic devices that may generate heat. Such containers may include one or more openings that allow for electronic connections to be made between components outside the container and components inside the container. The container may be configured to contain heat generated by the devices contained in the container to reduce exposure of other components outside the container. In other embodiments, electronic components that are sensitive to heat may be contained within the container such that the insulating material may reduce exposure to heat generated by components outside the container.

In some embodiments, the materials described above to construct the containers may be coated with one or more heat generating materials having properties that provide certain functionality, such as improved strength or insulation. In an embodiment, the materials may be coated in a heat generating material (e.g., paint, film, or other coating material), which may be transparent or substantially transparent, that gives off uniform heat when electrically charged. For instance, the heat generating material may include transparent electrodes arranged in one or more configurations, such as a network of transparent electrodes. The electrodes may comprise various materials, including, without limitation, indium-doped tin oxides, conducting polymers, carbon nanotubes (CNT), graphenes, metal grids, and metallic nanowires (e.g., such as silver nanowires). A power supply (e.g., an AC, a DC power supply, or combinations thereof) may be connected to the heat generating material to energize the heat generating material, causing the heat generating material to give off heat. Containers, or panels (e.g., vacuum insulation panes (VIPs)) constructed from the containers and configured according to some embodiments provided herein may have one or more materials coated in the aforementioned paint which could facilitate heating and insulating with the panels, such as integrated injection molded panels.

Illustrative uses for the heat generating material and panels using same include, without limitation, automotive and/or building materials. For example, the heat generating materials may include optically clear (for example, transparent, semi-transparent, or substantially transparent) heat generating film or other such coating. The heat generating film may be used in combination with products, such as a VIP or dual walled insulator, to provide a radiant heat source for the product. According to some embodiments, the heat generating material and/or products incorporating the heat generating material, may be molded into various shapes to fit various objects and/or structures, such as doors, walls, and/or ceiling or roof panels in cars, boats, planes, and/or buildings. For instance, in a building, the heat generating material and/or products incorporating the heat generating material may be co-molded into floor, ceiling or wall panels or used as a layer in drywall or as a component of flooring (for example, ceramic or laminate flooring) or ceiling panels.

Although the foregoing refers to particular embodiments, it will be understood that the present disclosure is not so limited. It will occur to those of ordinary skill in the art that various modifications may be made to the disclosed embodiments and that such modifications are intended to be within the scope of the present disclosure.

What is claimed is:

1. An insulated container comprising:
a container body having an opening configured to provide access to a container cavity disposed therein, the container body being formed from a body double-wall structure having a first body material layer and a second body material layer configured to form a body vacuum cavity within the body double-wall structure, the body vacuum cavity being configured to insulate the container body; and
a container cover being formed from a cover double-wall structure having a first cover material layer and a second cover material layer configured to form a cover vacuum cavity within the cover double-wall structure, the cover vacuum cavity being configured to insulate the container cover, the container cover being configured to cover the opening, thereby enclosing the container cavity and forming an enclosed insulated container for providing insulation for the container cavity.

2. The insulated container of claim 1, wherein the body vacuum cavity within the body double-wall structure has a thickness of about 2 mm to about 5 mm.

3. The insulated container of claim 1, wherein the body vacuum cavity and the cover vacuum cavity are at least partially filled with at least one of a getter and a desiccant.

4. The insulated container of claim 1, wherein the first body material layer, the second body material layer, the first cover material layer, and the second cover material layer comprise at least one of a metal, a polymer, a ceramic material, a high temperature composite material, carbon fiber, and a reflective material.

5. The insulated container of claim 1, wherein at least one of the first body material layer, the second body material layer, the first cover material layer, and the second cover material layer are coated with a reflective material or a low-emissivity material.

6. The insulated container of claim 1, wherein the container cover comprises an offset configured to overlap an outer surface of the opening to form an insulated seal between the container cover and the opening.

7. The insulated container of claim 1, further comprising a first plurality of projections configured to separate the first body material layer and the second body material layer.

8. The insulated container of claim 1, further comprising a second plurality of projections configured to separate the first cover material layer and the second cover material layer.

9. The insulated container of claim 1, wherein a pressure within the body vacuum cavity is about 10⁻² bar to about 10⁻⁸ bar.

10. The insulated container of claim 1, wherein at least one object is arranged within the container cavity, the at least one object comprising a building material, a portion of an automobile, power transmission cables, power transmission equipment, a refrigeration unit, an appliance, a pipe, a fluid container, a heat source, and medical packaging.

11. The insulated container of claim 1, wherein the container cavity is at least partially filled with an insulating material comprising at least one of the following: air, an inert gas, foam, aerogel, glass fibers, and a fluid.

12. The insulated container of claim 1, wherein the container body comprises a container base wall and four container side walls formed in a substantially box shape, the opening being arranged opposite the container base wall,
wherein the container cover comprises a cover base wall and four container side walls formed in a shape substantially corresponding to the substantially box shape of the container body such that at least a portion of the container body fits within the container cover to form a thermal seal.

13. The insulated container of claim 1, wherein the container body is formed from a single sheet of the at least one insulating material.

14. The insulated container of claim 1, wherein the container cover is formed from a single sheet of the at least one insulating material.

15. The insulated container of claim 1, wherein the container cavity is configured to receive at least one of the following: a battery, an electrical power source and an electronic device.

16. The insulated container of claim 1, wherein the at least one opening is configured as a port for facilitating an electronic connection of a battery stored within the cavity.

17. The insulated container of claim 1, wherein the at least one opening is configured as a port for facilitating a communication connection of an electronic device stored within the cavity.

18. A method of making an insulated container assembly, the method comprising:
forming a container body having an opening configured to provide access to a container cavity disposed therein, the container body being formed from a body double-wall structure having a first body material layer and a second body material layer configured to form a body vacuum cavity within the body double-wall structure; and
forming a container cover from a cover double-wall structure having a first cover material layer and a second cover material layer configured to form a cover vacuum cavity within the cover double-wall structure, the cover vacuum cavity being configured to insulate the container cover, the container cover being configured to cover the opening, thereby enclosing the container cavity and forming an enclosed insulated container for providing insulation for at least one object arranged within the container cavity.

19. The method of claim 18, further comprising forming a first plurality of projections configured to separate the first body material layer and the second body material layer.

20. The method of claim 18, further comprising forming a vacuum within the body vacuum cavity having a pressure of about 10⁻² bar to about 10⁻⁸ bar.
